(19) United States
(12) Patent Application Publication
(10) Pub. No.: US 2026/0249922 A1
(43) Pub. Date: Aug. 27, 2026

(54) CONNECTION STRUCTURE FOR ROOF SIDE AND C-PILLAR OF VEHICLE AND ASSEMBLY METHOD THEREOF

(71) Applicants: Hyundai Motor Company, Seoul (KR); Kia Corporation, Seoul (KR)

(72) Inventors: Bum-Joon Kim, Hwaseong-si (KR); Song-Jae Jeong, Hwaseong-si (KR); Ki-Hwan Park, Hwaseong-si (KR)

(21) Appl. No.: 19/270,942

(22) Filed: Jul. 16, 2025

(30) Foreign Application Priority Data
Feb. 26, 2025 (KR) 10-2025-0024991

(51) Int. Cl. B62D 25/06; B62D 25/04

(52) U.S. Cl. CPC B62D 25/06; B62D 25/04

(57) ABSTRACT

Provided is a connection structure for a roof side and a C-pillar of a vehicle and an assembly method thereof, designed to enhance rigidity at the area where the roof side and the C-pillar are connected in the vehicle. The connection structure for a roof side and a C-pillar of a vehicle according to the present disclosure includes a roof side outer reinforcement, a C-pillar upper reinforcement whose front end is spaced apart from the rear end of the roof side outer reinforcement by a predetermined distance, and a roof side outer rear reinforcement configured to connect the roof side outer reinforcement and the C-pillar upper reinforcement in the longitudinal direction of the vehicle.

### CROSS-REFERENCE TO RELATED APPLICATIONS

This application claims priority to Korean Patent Application No. 10-2025-0024991, filed on Feb. 26, 2025, which is incorporated herein by reference in its entirety.

### TECHNICAL FIELD

Exemplary embodiments of the present disclosure relate to a connection structure for a roof side and a C-pillar of a vehicle and an assembly method thereof, designed to enhance rigidity at the area where the roof side and the C-pillar are connected in the vehicle.

### BACKGROUND

An example of a side structure of a vehicle is illustrated in FIG. 1.

In the side structure of the vehicle, a roof side outer 111, which forms the upper side of the vehicle and supports the side of the roof, is formed along the longitudinal direction of the vehicle. An A-pillar 112, a B-pillar 113, and a C-pillar 114 are connected to the roof side outer 111 from the front of the vehicle.

To reinforce the rigidity of the roof side outer 111, a roof side outer reinforcement 121 (see FIG. 2) is provided to overlap the roof side outer 111.

The rear end of the roof side outer reinforcement 121 is connected to a C-pillar upper reinforcement 123 (see FIG. 2), which reinforces the upper portion of the C-pillar 114.

Recently, the distribution of electric vehicles has increased, and in these electric vehicles, the weight of the vehicle increases due to the installation of high-voltage batteries.

As such, as the weight of the vehicle increases, the collision load in a front-end collision of the vehicle affects the rear of the C-pillar 114.

For example, as illustrated in FIG. 1, when the vehicle collides with a barrier 130, the collision load is transmitted from the front to the rear of the vehicle (see the arrows in FIG. 1), and the collision load is transmitted to the rear of the C-pillar 114.

Accordingly, as illustrated in FIG. 3, in an area, denoted as B in FIG. 3, where the roof side outer reinforcement 121 and the C-pillar upper reinforcement 123 are connected, the rear portion of this area may be bent or fractured by the load applied in the longitudinal direction of the vehicle due to a collision, thus requiring an extension of high-strength components.

In addition, due to the driving of the vehicle, vibrations (see the up-and-down arrow in FIG. 3) input from the road through the wheels are transmitted to the upper portion of the vehicle, specifically to the roof side outer 111, the roof side outer reinforcement 121, and the C-pillar upper reinforcement 123 through the C-pillar 114.

Due to the application of high-strength components and the repetitive vibrations input through the wheels, the high-strength components serve as fixed walls and become vulnerable to torsion.

This causes the structure of the rear of the vehicle to deform in a front-end collision, which exacerbates the injuries of passengers in the second or third row.

Moreover, when assembling the side structure of the vehicle, the assembly order may vary depending on national regulations and the conditions of the assembly process, which may lead to differences in collision performance.

For example, as illustrated in FIG. 4, the roof side outer 111 and the roof side outer reinforcement 121 are assembled first. Subsequently, the C-pillar upper reinforcement 123 is assembled to the assembly of the roof side outer 111 and the roof side outer reinforcement 121 (see FIG. 5). However, since the outer side of the C-pillar upper reinforcement 123 is covered by the roof side outer 111, welding cannot be performed. Therefore, the C-pillar upper reinforcement 123 cannot be welded to the roof side outer reinforcement 121.

Alternatively, as illustrated in FIG. 6, the roof side outer reinforcement 121 and the C-pillar upper reinforcement 123 are first joined by welding. Subsequently, the roof side outer 111 is assembled to the outer side of the assembly of the roof side outer reinforcement 121 and the C-pillar upper reinforcement 123 (see FIG. 7).

According to this assembly order, the connection relationship changes. As a result, a problem arises where the collision performance at the areas where the roof side outer 111, the roof side outer reinforcement 121, and the C-pillar upper reinforcement 123 are connected may differ.

Undescribed reference numeral 115 is a wheelhouse where the wheel is mounted.

### SUMMARY

Various aspects are directed to providing a connection structure for a roof side and a C-pillar of a vehicle and an assembly method thereof, designed to enhance rigidity at the area where a roof side outer, a roof side outer reinforcement, and a C-pillar upper reinforcement are connected at the upper side of the vehicle and to ensure that rigidity remains consistent regardless of variations in the assembly order.

The connection structure for a roof side and a C-pillar of a vehicle according to the present disclosure includes a roof side outer reinforcement, a C-pillar upper reinforcement whose front end is spaced apart from the rear end of the roof side outer reinforcement by a predetermined distance, and a roof side outer rear reinforcement configured to connect the roof side outer reinforcement and the C-pillar upper reinforcement in the longitudinal direction of the vehicle.

The roof side outer rear reinforcement overlaps the roof side outer reinforcement by a predetermined length from the front end of the roof side outer rear reinforcement and overlaps the C-pillar upper reinforcement by a predetermined length from the rear end and the lower end of the roof side outer rear reinforcement, respectively.

The roof side outer reinforcement is provided with a first seating surface where the roof side outer rear reinforcement is seated at a predetermined length from the rear end of the roof side outer reinforcement, and a front connection portion formed at the front end of the roof side outer rear reinforcement is seated on the first seating surface.

The C-pillar upper reinforcement is provided with a second seating surface where the roof side outer rear reinforcement is seated at a predetermined length from the upper end and the front end of the C-pillar upper reinforcement, respectively, and the roof side outer rear reinforcement is seated on the second seating surface.

A rear connection portion is formed to extend rearwardly from the rear of the roof side outer rear reinforcement, a lower flange is formed below the front connection portion formed at the front end of the roof side outer rear reinforcement, a step portion is formed between the rear connection portion and the lower flange to create a stepped configuration, and the rear connection portion, the lower flange, and the step portion are seated on the second seating surface.

The roof side outer reinforcement is formed along the longitudinal direction of the vehicle and is assembled to overlap the roof side outer of the vehicle up to the area where the roof side outer reinforcement and the roof side outer rear reinforcement are connected.

The C-pillar upper reinforcement includes a first extension portion configured to be assembled to overlap the roof side outer of the vehicle by a predetermined length from the area connected to the roof side outer rear reinforcement, and a second extension portion configured to extend from the first extension portion and be assembled to overlap the C-pillar of the vehicle by a predetermined length from the area connected to the roof side outer rear reinforcement.

The roof side outer rear reinforcement does not overlap the area where the second extension portion extends from the first extension portion in the C-pillar upper reinforcement.

The roof side outer rear reinforcement is provided with a rear connection portion extending rearwardly from the rear of the roof side outer rear reinforcement, which is formed along an upper end of the first extension portion so that the rear connection portion overlaps the upper end of the first extension portion.

The roof side outer rear reinforcement is provided with a lower flange formed at a lower portion of the roof side outer rear reinforcement, which is seated on the second seating surface at a position forward of where the second extension portion branches.

The C-pillar upper reinforcement is provided with a vertical portion configured to extend in a width direction of the vehicle from the second extension portion and wrap around the C-pillar in the width direction of the vehicle, and a front flange configured to extend in the longitudinal direction of the vehicle from the vertical portion and wrap around the front end of the C-pillar.

The roof side outer rear reinforcement is made of a metal sheet having a higher tensile strength than the C-pillar upper reinforcement.

The roof side outer reinforcement and the roof side outer rear reinforcement are assembled, and then the C-pillar upper reinforcement is assembled to the assembly of the roof side outer reinforcement and the roof side outer rear reinforcement.

The C-pillar upper reinforcement and the roof side outer rear reinforcement are assembled, and then the roof side outer reinforcement is assembled to the assembly of the C-pillar upper reinforcement and the roof side outer rear reinforcement.

An assembly method of a connection structure for a roof side and a C-pillar of a vehicle includes assembling the connection structure for the roof side and the C-pillar of the vehicle, which includes a roof side outer reinforcement, a C-pillar upper reinforcement whose front end is spaced apart from the rear end of the roof side outer reinforcement by a predetermined distance, and a roof side outer rear reinforcement configured to connect the roof side outer reinforcement and the C-pillar upper reinforcement in the longitudinal direction of the vehicle. The roof side outer rear reinforcement is first assembled with either the roof side outer reinforcement or the C-pillar upper reinforcement, and the assembly is assembled with the remaining one of the roof side outer reinforcement and the C-pillar upper reinforcement.

The roof side outer reinforcement and the roof side outer rear reinforcement are assembled, and then the C-pillar upper reinforcement is assembled to the assembly of the roof side outer reinforcement and the roof side outer rear reinforcement.

The C-pillar upper reinforcement and the roof side outer rear reinforcement are assembled, and then the roof side outer reinforcement is assembled to the assembly of the C-pillar upper reinforcement and the roof side outer rear reinforcement.

In the connection structure for the roof side and the C-pillar of the vehicle and the assembly method according to the present disclosure with the above configuration, the high-strength roof side outer rear reinforcement connects the roof side outer reinforcement and the C-pillar upper reinforcement, so that the rigidity of the area where the roof side outer reinforcement and the C-pillar upper reinforcement are connected is enhanced.

Furthermore, the roof side outer rear reinforcement is selectively assembled with the roof side outer reinforcement and the C-pillar upper reinforcement, so that the same structure may be formed regardless of variations in the assembly order, and thus the same structure may be achieved regardless of the assembly order.

Thus, since the same structure is achieved regardless of variations in the assembly order, the same crash performance may be ensured.

### BRIEF DESCRIPTION OF THE DRAWINGS

FIG. 1 is a front view illustrating a side structure of a vehicle to which a connection structure for a roof side and a C-pillar of the vehicle in the related art is applied.

FIG. 2 is a front view illustrating the connection structure for a roof side and a C-pillar of the vehicle in the related art.

FIG. 3 is a schematic view illustrating the occurrence of torsion at a connection area of a roof side outer reinforcement and a C-pillar upper reinforcement in the connection structure for a roof side and a C-pillar of the vehicle in the related art.

FIG. 4 is a front view illustrating an embodiment of an assembly order of the connection structure for a roof side and a C-pillar of the vehicle in the related art.

FIG. 5 is a cross-sectional view taken along line Ⅰ-Ⅰ in FIG. 4.

FIG. 6 is a front view illustrating another embodiment of an assembly order of the connection structure for a roof side and a C-pillar of the vehicle in the related art.

FIG. 7 is a cross-sectional view taken along line Ⅱ-Ⅱ in FIG. 6.

FIG. 8 is a front view illustrating a connection structure for a roof side and a C-pillar of a vehicle according to the present disclosure.

FIG. 9 is an exploded perspective view of the connection structure for a roof side and a C-pillar of the vehicle according to the present disclosure.

FIG. 10 is a schematic view illustrating an assembled relationship of the connection structure for a roof side and a C-pillar of the vehicle according to the present disclosure.

FIG. 11 is a cross-sectional view taken along line Ⅲ-Ⅲ in FIG. 8.

FIG. 12 is a cross-sectional view taken along line Ⅳ-Ⅳ in FIG. 8.

FIG. 13 is a front view illustrating welding and bonding areas according to an embodiment of an assembly order of the connection structure for a roof side and a C-pillar of the vehicle according to the present disclosure.

FIG. 14 is a front view illustrating welding and bonding areas according to another embodiment of an assembly order of the connection structure for a roof side and a C-pillar of the vehicle according to the present disclosure.

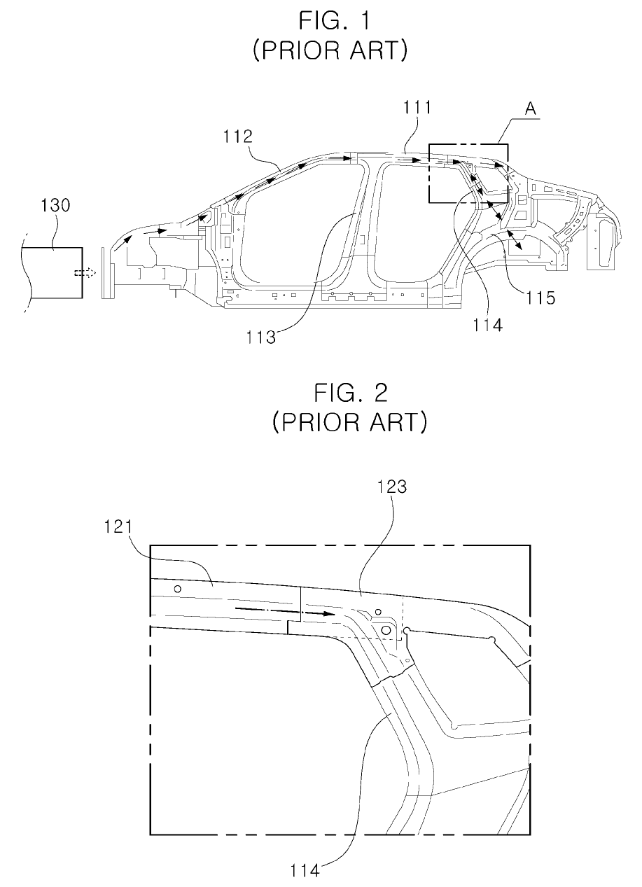

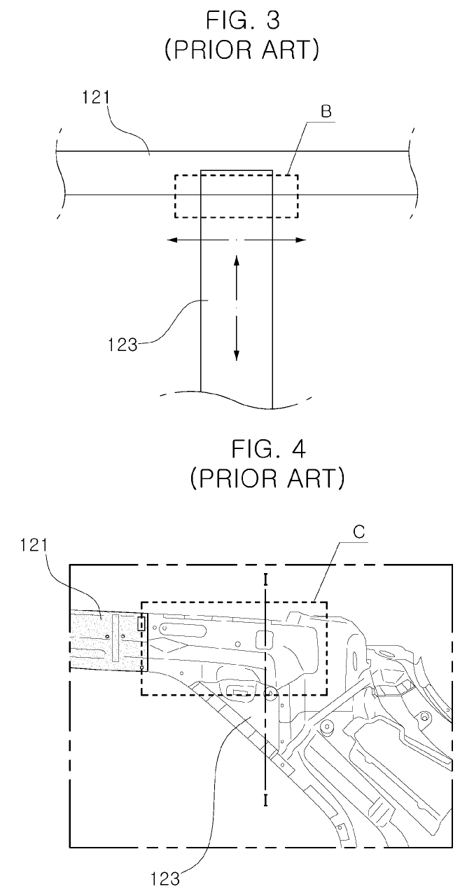

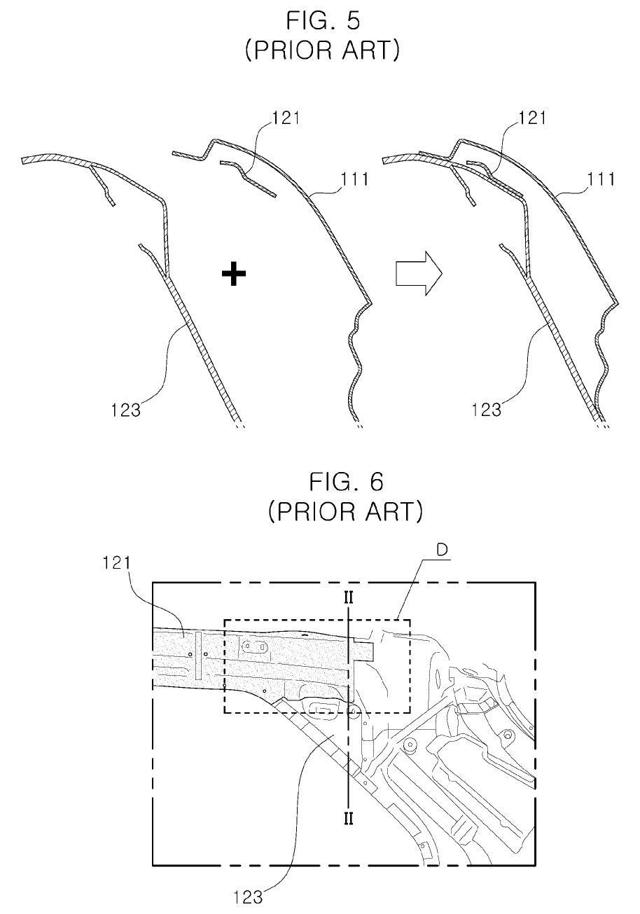

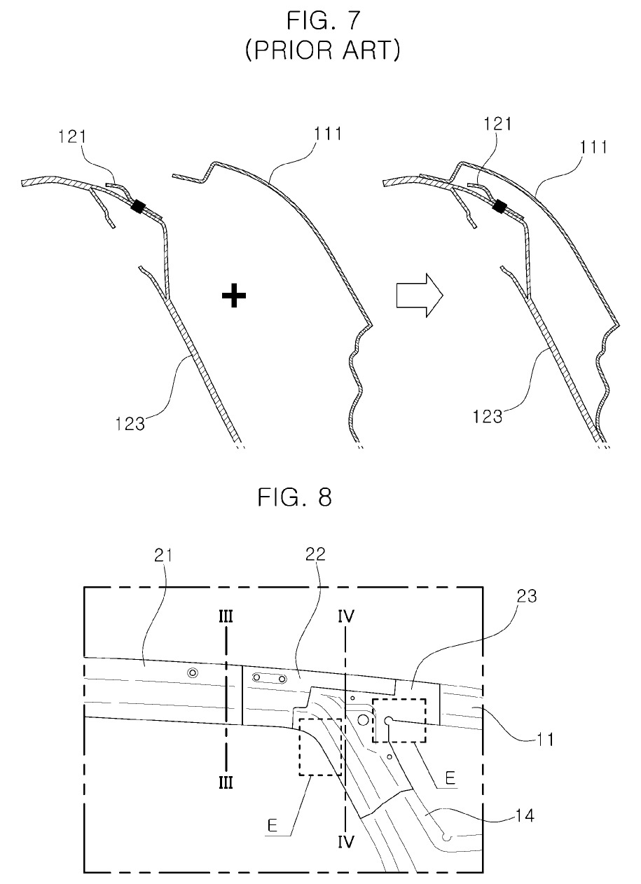

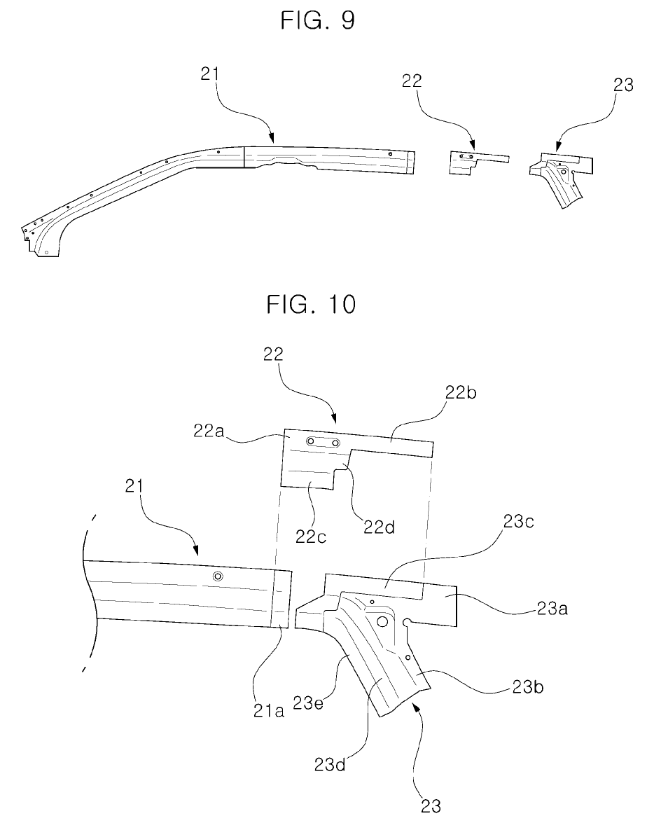

### DETAILED DESCRIPTION OF ILLUSTRATIVE EMBODIMENTS

Hereinafter, a connection structure for a roof side and a C-pillar of a vehicle and an assembly method thereof according to the present disclosure will be described in detail with reference to the accompanying drawings.

As shown, for example, in FIG. 8, the connection structure for a roof side and a C-pillar of a vehicle according to the present disclosure includes a roof side outer reinforcement 21, a C-pillar upper reinforcement 23 whose front end is spaced apart from the rear end of the roof side outer reinforcement 21 by a predetermined distance, and a roof side outer rear reinforcement 22 configured to connect the roof side outer reinforcement 21 and the C-pillar upper reinforcement 23 in the longitudinal direction of the vehicle.

A roof side outer 11 is formed at the upper portion of a side structure of the vehicle.

The roof side outer 11 is formed in the longitudinal direction of the vehicle and serves to support the side of the vehicle's roof.

The upper ends of an A-pillar, a B-pillar, and a C-pillar 14 are each connected from the front end toward the rear end of the roof side outer 11.

The roof side outer 11 serves as a path through which the collision load is transmitted in a front-end collision of the vehicle.

The roof side outer reinforcement 21 overlaps the roof side outer 11 and is assembled to the roof side outer 11. The roof side outer reinforcement 21 is assembled to the roof side outer 11, which serves to reinforce the rigidity of the roof side outer 11.

The roof side outer reinforcement 21 is a component where the material and thickness have a significant impact on collision performance, and may be formed in a straight line along the longitudinal direction of the vehicle to maintain the load path in a front collision and a side collision.

The C-pillar upper reinforcement 23 wraps around the upper end of the C-pillar 14 and a portion of the roof side outer 11. That is, the C-pillar upper reinforcement 23 is assembled in a manner that wraps around the upper end of the C-pillar 14 and the area where the roof side outer 11 and the C-pillar 14 are connected. As a result, the C-pillar upper reinforcement 23 reinforces the rigidity of the upper end of the C-pillar 14 and the area where the roof side outer 11 and the C-pillar 14 are connected.

The front end of the C-pillar upper reinforcement 23 is arranged to be spaced by a predetermined distance from the rear end of the roof side outer reinforcement 21.

The roof side outer rear reinforcement 22 connects the roof side outer reinforcement 21 and the C-pillar upper reinforcement 23, which are spaced apart from each other. That is, the roof side outer rear reinforcement 22 serves to connect the roof side outer reinforcement 21 and the C-pillar upper reinforcement 23 in the longitudinal direction of the vehicle.

In FIG. 10, the rear end of the roof side outer reinforcement 21 and the front end of the C-pillar upper reinforcement 23 are spaced by a certain distance, which is connected by the roof side outer rear reinforcement 22.

The roof side outer rear reinforcement 22 overlaps the roof side outer reinforcement 21 by a predetermined length from the front end of the roof side outer rear reinforcement 22, and overlaps the C-pillar upper reinforcement 23 by a predetermined length from both the rear and lower ends of the roof side outer rear reinforcement 22.

The roof side outer rear reinforcement 22 overlaps the roof side outer reinforcement 21, and the roof side outer reinforcement 21 is provided with a first seating surface 21a where the roof side outer rear reinforcement 22 is seated at a predetermined length from the rear end of the roof side outer reinforcement 21. The first seating surface 21a is formed with a step so as to have a different height than the roof side outer reinforcement 21. That is, as the roof side outer rear reinforcement 22 is seated on the first seating surface 21a, the roof side outer rear reinforcement 22 has the same height as the roof side outer reinforcement 21.

A front connection portion 22a, formed at the front end of the roof side outer rear reinforcement 22, is seated on the first seating surface 21a, so that the roof side outer rear reinforcement 22 overlaps the roof side outer reinforcement 21.

The overlap area of the roof side outer rear reinforcement 22 and the roof side outer reinforcement 21 is welded or bonded with applied structural adhesive, so that the roof side outer rear reinforcement 22 is connected to the roof side outer reinforcement 21.

Similarly, the roof side outer rear reinforcement 22 overlaps the C-pillar upper reinforcement 23.

The C-pillar upper reinforcement 23 is provided with a second seating surface 23c where the lower end and rear end of the roof side outer rear reinforcement 22 are seated at a predetermined length from the upper and front ends of the C-pillar upper reinforcement 23, respectively. Specifically, a rear connection portion 22b, connected to the rear of the roof side outer rear reinforcement 22, is formed at the rear end of the roof side outer rear reinforcement 22. A lower flange 22c is formed below the front connection portion 22a, and a step portion 22d is formed between the rear connection portion 22b and the lower flange 22c to create a stepped configuration, so that the rear connection portion 22b, the lower flange 22c, and the step portion 22d are seated on the second seating surface 23c. The second seating surface 23c is also formed with a step so as to have a different height than the C-pillar upper reinforcement 23, allowing the roof side outer reinforcement 21 to be easily seated. That is, as the roof side outer rear reinforcement 22 is seated on the second seating surface 23c, the roof side outer rear reinforcement 22 has the same height as the C-pillar upper reinforcement 23. The step portion 22d reinforces the rigidity of the area where the lower flange 22c and the rear connection portion 22b are connected.

In the overlapped state where the rear and lower ends of the roof side outer rear reinforcement 22 are seated on the second seating surface 23c, the overlap area is welded or bonded with applied structural adhesive, so that the roof side outer rear reinforcement 22 is connected to the C-pillar upper reinforcement 23.

The C-pillar upper reinforcement 23 is provided with a first extension portion 23a configured to be assembled to overlap the roof side outer 11 of the vehicle by a predetermined length from the area connected to the roof side outer rear reinforcement 22, and a second extension portion 23b configured to extend from the first extension portion 23a and be assembled to overlap the C-pillar 14 of the vehicle by a predetermined length from the area connected to the roof side outer rear reinforcement 22.

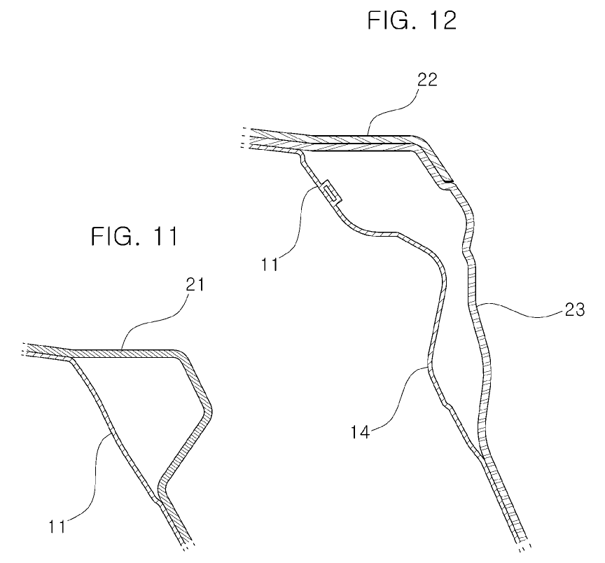

In the C-pillar upper reinforcement 23, the first extension portion 23a is formed along the longitudinal direction of the vehicle to reinforce the roof side outer 11. The roof side outer 11 is reinforced by the roof side outer reinforcement 21 up to the roof side outer rear reinforcement 22, and has the cross-sectional structure as illustrated in FIG. 11. That is, the roof side outer reinforcement 21 is assembled to overlap the roof side outer 11 of the vehicle up to the area where the roof side outer reinforcement 21 and the roof side outer rear reinforcement 22 are connected. Subsequently, the roof side outer 11 is reinforced by the roof side outer rear reinforcement 22, and subsequent to the roof side outer rear reinforcement 22, the roof side outer 11 is reinforced by the first extension portion 23a of the C-pillar upper reinforcement 23. Specifically, the roof side outer rear reinforcement 22 overlaps the first extension portion 23a of the C-pillar upper reinforcement 23 by a predetermined length at the area where the rear connection portion 22b is formed, and has a cross-sectional structure as illustrated in FIG. 12.

In FIG. 8, the roof side outer 11 is illustrated to be exposed rearward from the first extension portion 23a.

In addition, the C-pillar upper reinforcement 23 extends in the width direction of the vehicle from the second extension portion 23b, and is provided with a vertical portion 23d which wraps around the C-pillar 14 in the width direction of the vehicle, and a front flange 23e which extends in the longitudinal direction of the vehicle from the vertical portion 23d and wraps around the front end of the C-pillar 14.

In the C-pillar upper reinforcement 23, the first extension portion 23a is formed in the longitudinal direction of the vehicle, the second extension portion 23b is formed substantially in the height direction of the vehicle, and the vertical portion 23d and the front flange 23e wraps around the front end of the C-pillar 14. The C-pillar upper reinforcement 23 has a cross-section that includes both the longitudinal and vertical directions of the vehicle. The second extension portion 23b serves as a main path for transmitting torsional rigidity in the vertical direction.

The roof side outer rear reinforcement 22 does not overlap the area where the second extension portion 23b extends from the first extension portion 23a. That is, by avoiding the area denoted as ‘E’ in FIG. 8, the roof side outer rear reinforcement 22 is connected to the C-pillar upper reinforcement 23. That is, the rear connection portion 22b is formed along the upper end of the first extension portion 23a, and the rear connection portion 22b overlaps the upper end of the first extension portion 23a, so that the rear connection portion 22b does not overlap the second extension portion 23b, which extends downward from the first extension portion 23a. In addition, the lower flange 22c is seated on the second seating surface 23c at a position forward of where the second extension portion 23b branches, so that the lower flange 22c does not overlap the second extension portion 23b.

The roof side outer rear reinforcement 22 is connected to the C-pillar upper reinforcement 23 only up to the point where the cross-section widens. The roof side outer rear reinforcement 22 is made of a metal sheet having a higher tensile strength than the C-pillar upper reinforcement 23. For example, the roof side outer rear reinforcement 22 may be made of a steel sheet having a higher tensile strength than the C-pillar upper reinforcement 23.

Accordingly, since the area denoted as ‘E’ in FIG. 8 is a corner portion where torsional load is concentrated, the roof side outer rear reinforcement 22 is configured to avoid this area, which ensures torsional rigidity.

Hereinafter, an assembly method of a connection structure for a roof side and a C-pillar of a vehicle according to the present disclosure is described as follows.

The assembly method for the connection structure for a roof side and a C-pillar of a vehicle according to the present disclosure includes assembling the previously described roof side outer reinforcement 21, C-pillar upper reinforcement 23, and roof side outer rear reinforcement 22. In this method, the roof side outer rear reinforcement 22 is first assembled with either the roof side outer reinforcement 21 or the C-pillar upper reinforcement 23, and assembled with the remaining one of the roof side outer reinforcement 21 and the C-pillar upper reinforcement 23.

The roof side outer reinforcement 21 and the C-pillar upper reinforcement 23 are not directly connected, but are connected via the roof side outer rear reinforcement 22. Accordingly, the roof side outer rear reinforcement 22 is first connected to either the roof side outer reinforcement 21 or the C-pillar upper reinforcement 23, and connected to the remaining one, so that the same structure may be achieved regardless of the assembly order. That is, regardless of differences in national regulations or assembly process conditions, the roof side outer rear reinforcement 22 is first assembled with either the roof side outer reinforcement 21 or the C-pillar upper reinforcement 23, so that the same structure may be ultimately achieved.

FIG. 13 shows that the roof side outer reinforcement 21 and the roof side outer rear reinforcement 22 are first assembled by welding, and the C-pillar upper reinforcement 23 is assembled to this welded assembly.

The roof side outer reinforcement 21 and the roof side outer rear reinforcement 22 are assembled by welding (W), and the C-pillar upper reinforcement 23 is bonded using structural adhesive. In FIG. 13, in the area denoted as box ‘F,’ the roof side outer reinforcement 21 and the roof side outer rear reinforcement 22 are welded (W), and in the area denoted as box ‘G,’ the C-pillar upper reinforcement 23 is bonded using structural adhesive. Finally, the areas where the roof side outer rear reinforcement 22 and the C-pillar upper reinforcement 23 overlap the roof side outer 11, similar to a flange, are assembled by welding (W). For example, an example of assembly by welding (W) within the area denoted as box ‘G’ is illustrated.

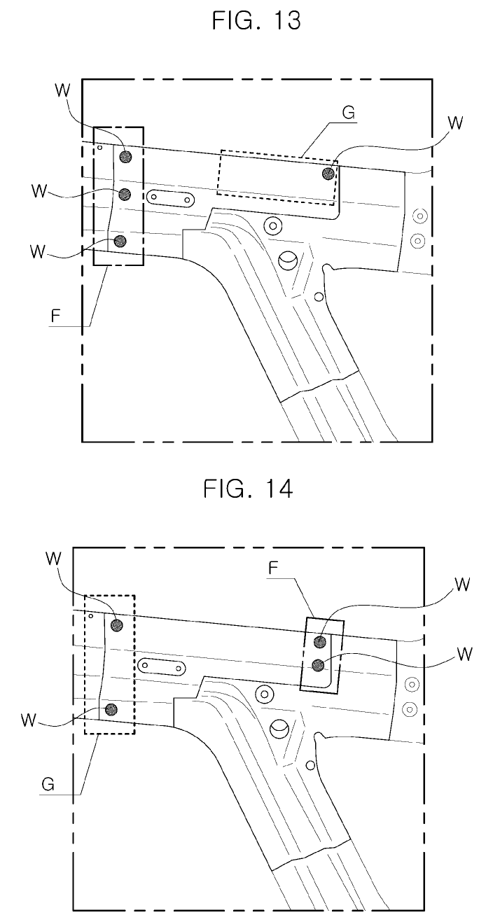

FIG. 14 shows an example in which the C-pillar upper reinforcement 23 and the roof side outer rear reinforcement 22 are first assembled by welding (W), and the roof side outer reinforcement 21 is assembled by adhesive bonding. In the area denoted as box ‘F,’ the C-pillar upper reinforcement 23 and the roof side outer rear reinforcement 22 are welded (W), and in the area denoted as box 'G,' the roof side outer reinforcement 21 is adhesively bonded.

Subsequently, within the area denoted as box 'G,' welding (W) is performed in the overlapped state, from the flange portion to the overlapped roof side outer 11.

As such, the roof side outer rear reinforcement 22 is first selectively assembled with either the roof side outer reinforcement 21 or the C-pillar upper reinforcement 23, and assembled with the remaining one. This ensures that, regardless of differences in national regulations or factory conditions that may vary the assembly order, the same structure is achieved, and thus the same crash performance is ensured.

What is claimed is:

1. A connection structure for a roof side and a C-pillar of a vehicle, the connection structure comprising:
a roof side outer reinforcement;
a C-pillar upper reinforcement comprising a C-pillar upper reinforcement front end spaced apart from a roof side outer reinforcement rear end of the roof side outer reinforcement by a predetermined distance; and
a roof side outer rear reinforcement configured to connect the roof side outer reinforcement and the C-pillar upper reinforcement in a longitudinal direction of the vehicle.

2. The connection structure of claim 1, wherein:
the roof side outer rear reinforcement overlaps the roof side outer reinforcement by a first predetermined length from a roof side outer rear reinforcement front end of the roof side outer rear reinforcement, and
the roof side outer rear reinforcement overlaps the C-pillar upper reinforcement by a second predetermined length from a roof side outer rear reinforcement rear end and a roof side outer rear reinforcement lower end of the roof side outer rear reinforcement, respectively.

3. The connection structure of claim 2, wherein the roof side outer reinforcement is provided with a first seating surface where the roof side outer rear reinforcement is seated at a third predetermined length from the roof side outer reinforcement rear end, and a front connection portion formed at the roof side outer rear reinforcement front end is seated on the first seating surface.

4. The connection structure of claim 2, wherein:
the C-pillar upper reinforcement is provided with a second seating surface where the roof side outer rear reinforcement is seated at a third predetermined length from a C-pillar upper reinforcement upper end and a C-pillar upper reinforcement front end of the C-pillar upper reinforcement, respectively, and
the roof side outer rear reinforcement is seated on the second seating surface.

5. The connection structure of claim 4, wherein:
a rear connection portion is formed to extend rearwardly from a rear of the roof side outer rear reinforcement,
a lower flange is formed below a front connection portion formed at the roof side outer rear reinforcement front end,
a step portion is formed between the rear connection portion and the lower flange to create a stepped configuration, and
the rear connection portion, the lower flange, and the step portion are seated on the second seating surface.

6. The connection structure of claim 1, wherein the roof side outer reinforcement is formed along the longitudinal direction of the vehicle and is assembled to overlap a roof side outer of the vehicle up to an area where the roof side outer reinforcement and the roof side outer rear reinforcement are connected.

7. The connection structure of claim 4, wherein the C-pillar upper reinforcement comprises:
a first extension portion configured to be assembled to overlap a roof side outer of the vehicle by a fourth predetermined length from a first area connected to the roof side outer rear reinforcement; and
a second extension portion configured to extend from the first extension portion and be assembled to overlap the C-pillar of the vehicle by a fifth predetermined length from a second area connected to the roof side outer rear reinforcement.

8. The connection structure of claim 7, wherein the roof side outer rear reinforcement does not overlap a third area where the second extension portion extends from the first extension portion in the C-pillar upper reinforcement.

9. The connection structure of claim 7, wherein the roof side outer rear reinforcement is provided with a rear connection portion extending rearwardly from a rear of the roof side outer rear reinforcement, which is formed along a first extension portion upper end of the first extension portion so that the rear connection portion overlaps the first extension portion upper end.

10. The connection structure of claim 7, wherein the roof side outer rear reinforcement is provided with a lower flange formed at a lower portion of the roof side outer rear reinforcement, which is seated on the second seating surface at a position forward of where the second extension portion branches.

11. The connection structure of claim 7, wherein the C-pillar upper reinforcement is provided with:
a vertical portion configured to extend in a width direction of the vehicle from the second extension portion and wrap around the C-pillar in the width direction of the vehicle, and
a front flange configured to extend in the longitudinal direction of the vehicle from the vertical portion and wrap around a C-pillar front end of the C-pillar.

12. The connection structure of claim 1, wherein the roof side outer rear reinforcement is made of a metal sheet having a higher tensile strength than the C-pillar upper reinforcement.

13. The connection structure of claim 1, wherein the roof side outer reinforcement and the roof side outer rear reinforcement are assembled to form an assembly, and then the C-pillar upper reinforcement is assembled to the assembly.

14. The connection structure of claim 1, wherein the C-pillar upper reinforcement and the roof side outer rear reinforcement are assembled to form an assembly, and then the roof side outer reinforcement is assembled to the assembly.

15. An assembly method of a connection structure for a roof side and a C-pillar of a vehicle, the assembly method comprising:
assembling the connection structure for the roof side and the C-pillar of the vehicle, the connection structure comprising:
a roof side outer reinforcement;
a C-pillar upper reinforcement comprising a C-pillar upper reinforcement front end spaced apart from a roof side outer reinforcement rear end of the roof side outer reinforcement by a predetermined distance; and
a roof side outer rear reinforcement configured to connect the roof side outer reinforcement and the C-pillar upper reinforcement in a longitudinal direction of the vehicle,
wherein the roof side outer rear reinforcement is first assembled with either the roof side outer reinforcement or the C-pillar upper reinforcement to form an assembly, and then the assembly is assembled with a remaining one of the roof side outer reinforcement and the C-pillar upper reinforcement.

16. The assembly method of claim 15, wherein the roof side outer reinforcement and the roof side outer rear reinforcement are assembled to form the assembly, and then the C-pillar upper reinforcement is assembled to the assembly.

17. The assembly method of claim 15, wherein the C-pillar upper reinforcement and the roof side outer rear reinforcement are assembled to form the assembly, and then the roof side outer reinforcement is assembled to the assembly.

18. A vehicle, comprising:
a roof side;
a C-pillar; and
a connection structure comprising:
a roof side outer reinforcement;
a C-pillar upper reinforcement; and
a roof side outer rear reinforcement configured to connect the roof side outer reinforcement and the C-pillar upper reinforcement in a longitudinal direction of the vehicle.

19. The vehicle of claim 18, wherein a front end of the C-pillar upper reinforcement is spaced apart from a rear end of the roof side outer reinforcement by a predetermined distance.

20. The vehicle of claim 18, wherein:
the roof side outer rear reinforcement overlaps the roof side outer reinforcement by a first predetermined length, and
the roof side outer rear reinforcement overlaps the C-pillar upper reinforcement by a second predetermined length.
